(19) United States
(12) Patent Application Publication
(10) Pub. No.: US 2021/0206387 A1
(43) Pub. Date: Jul. 8, 2021

(54) METHODOLOGIES, SYSTEMS, AND COMPONENTS FOR INCREMENTAL AND CONTINUAL LEARNING FOR SCALABLE IMPROVEMENT OF AUTONOMOUS SYSTEMS

(71) Applicants: VOLKSWAGEN AKTIENGESELLSCHAFT, Wolfsburg (DE); AUDI AG, Ingolstadt (DE); PORSCHE AG, Stuttgart (DE)

(72) Inventors: Pratik BRAHMA, San Mateo, CA (US); Nikhil J. GEORGE, Palo Alto, CA (US); Adrienne OTHON, Kensington, CA (US)

(21) Appl. No.: 17/059,664

(22) PCT Filed: May 31, 2019
(86) PCT No.: PCT/US2019/034857

§ 371 Date: Nov. 30, 2020

Related U.S. Application Data
(60) Provisional application No. 62/679,456, filed on Jun. 1, 2018.

(51) Int. Cl. B60W 60/00; G06K 9/62; G06K 9/00; B60W 50/10; G06F 9/355

(52) U.S. Cl. CPC B60W 60/001; G06K 9/6259; G06F 9/3555; B60W 50/10; G06K 9/00791

(57) ABSTRACT

Autonomous driving systems may be provided with one or more sensors configured to capture perception data, a model configured to be continually trained in the transportation vehicle and a scalable subset memory configured to store a subset of a dataset previously used to train a model. A processor may be provided for continually training the model in the transportation vehicle using captured perception data previously unseen and the subset and for generating a new subset of data to be stored so that the model avoids catastrophic forgetting.

### PRIORITY CLAIM

This application is a U.S. National Phase of International Patent Application No. PCT/US2019/034857, filed 31 May 2019, which claims priority to U.S. Provisional Application Ser. No. 62/679,456, filed 1 Jun. 2018, the disclosures of which are incorporated herein by reference in their entireties.

### BACKGROUND

The present disclosure relates to systems, components and methodologies for incremental and continuous learning for scalable improvement for machine learning. In particular, the present disclosure relates to systems, components and methodologies for continuous learning while avoiding catastrophic forgetting in machine learning for autonomous vehicle systems.

### SUMMARY

Autonomous driving systems may be provided with one or more sensors configured to capture perception data, an autonomous or Adaptive Driver Assistance System model configured to be continually trained in the transportation vehicle, a scalable subset memory configured to store a subset of a dataset previously used to train a model, and means for continually training the model in the transportation vehicle using captured perception data previously unseen and the subset and generating a new subset of data to be stored so that the model avoids catastrophic forgetting.

In some embodiments, the scalable subset memory may be configured to store a subset representative of data used in each additional training of the model. In some embodiments, the captured perception data is triggered by one of user input, transition from autonomous to manual driving, or an override of an automatic tagging of the data.

According to another embodiment, a system for controlling the training of artificial intelligence models in a plurality of cars may comprise a fleet of transportation vehicles each provided with a model that may be continuously trained with scalable memory. A central server may be configured to communicate with each transportation vehicle and receive update on the status of the data collection at each transportation vehicle. The server may also be configured to evaluate corresponding performance of each transportation vehicle in identifying and labeling driving scenarios, determine deficiencies in the transportation vehicle training and performance with respect to one or more of the driving scenarios. The server may be able to transmit instructions to each transportation vehicle regarding where each transportation vehicle should travel to in order to collect a new set of data.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 illustrates a schematic flow diagram of how a model may be trained based on new data, a subset of the new data is stored in a scalable memory, and in subsequent trainings the model is trained on new data as well as a replayed subset of stored data that it was previously was trained on in order to avoid catastrophic forgetting by the model;

FIG. 2 describes a method for identifying the subset of data in FIG. 1 to be stored in the scalable memory to be used in subsequent trainings of the model;

FIG. 3 illustrates a method for transportation vehicle training according to FIG. 1 in which the in-transportation vehicle manual labeling and tagging of collected training data is reduced;

FIG. 4 is a schematic diagram illustrating how a fleet of transportation vehicles may communicate with a common server in order to maximize training of FIGS. 1-3 by collecting data across transportation vehicles and issuing instructions to the transportation vehicles based on the data collected; and

FIG. 5 is an exemplary transportation vehicle and corresponding transportation vehicle system for executing the methods and communications as described in FIGS. 1-4.

### DETAILED DESCRIPTION

Deep neural networks, and in general most machine learning models, often suffer from the problem of forgetting the knowledge obtained from previous observations when they are retrained with new data. This phenomenon is referred to as catastrophic forgetting. Since machine learning and Artificial Intelligence (AI) are actively becoming involved in autonomous driving systems and Adaptive Driver Assistance Systems (ADAS), it is useful to inculcate continuity in the learning process so that these data driven functionalities can be developed in a scalable manner.

Models, such as machine learning, deep neural network, and other types of AI, may be updated in phases when new data comes in. New data may be collected whenever the vehicle gets a trigger. The triggering process may either be human input or automated through some other AI module. The naïve way to prohibit catastrophic forgetting is to retrain the model by combining the previous and newly obtained data. This asks for a huge storage requirement as well as the burden of jointly retraining the model in terms of both time and computation (for example, Graphics Processing Units) usage cost. The disclosed systems and methodologies avoid these burdens and provide a technical improvement for model training by carefully choosing a subset of the older data and replaying it for retraining the model along with the new data. The subset samples may be chosen in a way that they are representative of the entire distribution as well as are diverse enough to reduce redundancy. The subset memory keeps growing in a scalable manner as new data comes in phases but this eliminates the need of storing all the data in the memory simultaneously. In addition, the computation time is reduced for each retraining phase.

The subset selection may be done in various ways. Formulating it as a submodular optimization function has the advantage of having a lower bound guarantee on the representativeness of the subset chosen. Along with representativeness, data points that are diverse enough may also be included. A way of ensuring diversity is by dividing the data into partitions based on some aspect (like environment type, or output range, etc.) and running the subset selection on each partition separately. Replaying such a subset along with the new data ensures that the model does not forget the teachings of the past. Such form of continual learning can be shown to work in tasks like object recognition, trajectory prediction, scene understanding etc.

Currently, labeling done during data collection campaigns is done manually by a testing person sitting in the passenger seat trying to tag every situation as he sees while driving. With the disclosed subset replay based continuous learning, the disclosed embodiments provide a technical improvement in that labeling during data collection may be automated to a certain extent. By employing a model that does scenario recognition in a transportation vehicle and a computing resource, such as a processor, the model may be retrained while driving. Every time a new scenario is encountered, it may be labeled once by the human tester and provided as an input to the model, which continuously updates itself. When this type of scenario is encountered again, the model recognizes it and proposes it to the human tester. This substantially reduces the total number of manual clicks that a human tester has to do while driving.

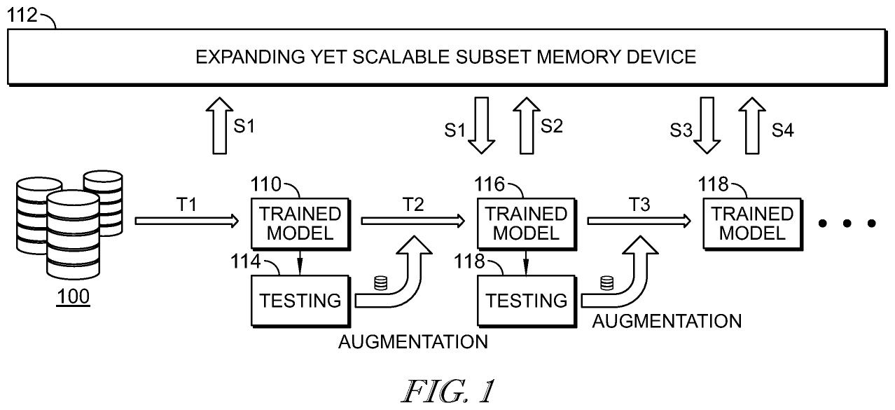

As can be seen in FIG. 1, a model 100, such as a machine learning model, or AI model, is provided in to be trained. In this example, the model may be an autonomous or Adaptive Driver Assistance Systems (ADAS) model that may be integrated in a transportation vehicle. The model 100 is subjected to an initial training T1 using an initial set of data, such as perception data recorded by sensors that detect conditions surrounding the vehicle, resulting in a trained model 110. From the initial training T1, a subset of data S1 of the initial set of data is selected and incorporated into a memory device 112, as a scalable subset memory. The trained model 110.

Trained model 110, may be subject to testing 114 in which a data collection campaign records novel or edge case scenarios that were not seen by the trained model 110 during the initial training T1 as new data. The trained model 110 may then be trained on this new data along with a memory replay of the stored subset of data S1 in a second training T2, resulting in trained model 116. A subset S2 of the new data may be selected and added to the memory device 112 to expand the scalable subset of memory in the memory device 112 and be used in future trainings of the trained model 116. For example, trained model 116 may be subjected to a second testing 118 in which a data collection campaign records further novel or edge case scenarios that were not seen by the trained model 116 during second training T2 as new data. The trained model 116 may then be trained on this new data along with a memory replay of the stored subset of data S3, which includes the subsets S1 and S2, in a third training T3, resulting in trained model 118. A subset S4 of the new data may be selected, while discarding redundant data, and added to the memory device 112 to expand the scalable subset of memory in the memory device 112 and be used in future trainings of the trained model 118. This method may be repeated in future testing and training sessions as part of a continuous learning process.

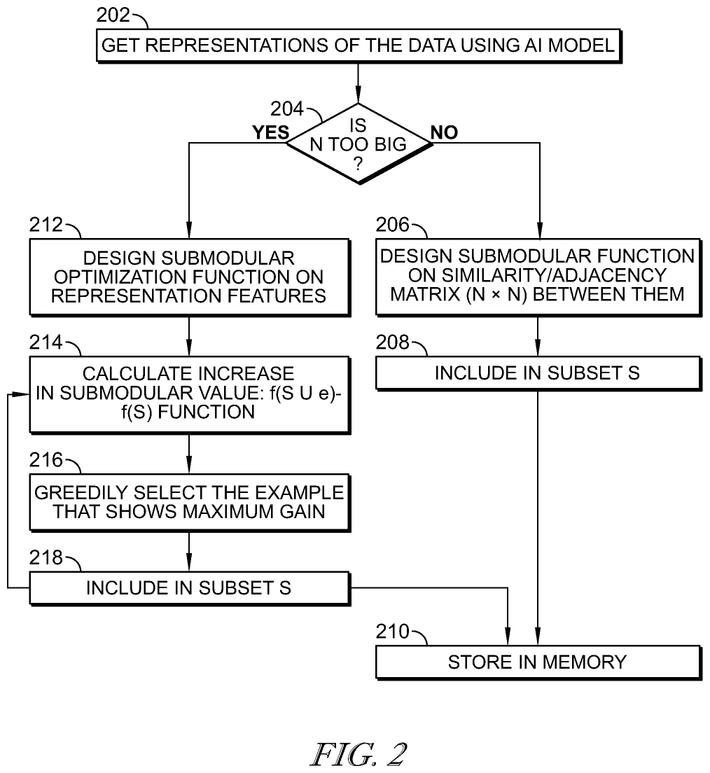

An illustrative method for selecting the subset of training data of FIG. 1 is shown in FIG. 2. First, the AI model gets representations of collected data at 202, for example, a number “N” of data samples. The collected data may be collected from images and videos using deep learning of the AI network to perform feature extraction. By way of example, the intermediate layer output of a deep neural network with rectified linear unit (ReLU) activation may be used. Therefore, features may be extracted from the “lth” layer of a neural network that has “d” dimensional neurons with ReLU activation. If the d-dimensional representations of the input data are too large then the “N” may be determined to be too large at 204. The determination is based on a fixed budget “b” that is a factor of the size of the memory available and required computational resource and retraining time.

Next, a submodular optimization function on representation features in the training data may be determined at 212. For example, each of iₖ (commonality of neural activation), hₖ (actual feature value), and tₖ (iteration) may be computed for each diversity-based partition in the training data when a neuron of the neural network is activated. Diversity-based partitions of the training data may be set by dividing the training set data to maximize diversity and coverage as is disclosed in Applicant's “Subset Replay based Continual Learning for Scalable Improvement of Autonomous Systems” incorporated in its entirety by reference.

For a dataset containing N observations, there is a feature matrix

H ∈ [symbol] ^{N×d}.

Similar to a computation of term frequency-inverse document frequency “TF-IDF”, commonality of neural activation may be calculated by

$${i}_{k} = \vert log ( \frac{1}{( {a}_{k} + δ )} ) \vert$$

where δ is a very small number to avoid division by zero in cases where a particular neuron is never activated and aₖ denotes the fraction of times when the neuron k is activated (or nonzero) in the feature matrix. When iₖ is multiplied with the actual feature output, it diminishes the weight on commonly occurring neural activations as compared to increasing the importance of rarely occurring ones. For every data point i, the actual feature Hₖⁱ value may be normalized for every neuron by multiplying it with iₖ as follows:

tₖⁱ=hₖⁱ×iₖ.

For every feature or neural activation k, the modular score for a given subset S may be computed as:

$${m}_{k} ( S ) = {\sum }_{i ∈ S} {t}_{k}^{i} .$$

The over-all submodular function may be

$$f ( S ) = {\sum }_{k = 1}^{d} \sqrt{{m}_{k} ( S )} .$$

Increase in submodular value may be determined 214 based on the function (f(Sₜ₋₁ ∪ e)−f(Sₜ₋₁). Over multiple iterations, a greedy, or submodular optimization, algorithm tries to scan over the entire set of features and pick that particular element “e” which maximizes the conditional gain from its current submodular value at 216. For every iteration t,

e*ₜ=argmaxₑ_{ₜ}_{∈V-S}_{_{t−1}}(f(Sₜ₋₁ ∪ e)−f(Sₜ₋₁)).

Each element “e” which maximizes conditional gain may be included in the subset 218 to be stored in memory 210.

Subsets obtained from each of the partitions may be concatenated to form the final subset. The operations performed at 214-218 may be repeated until the memory budget b is met. Given a total budget of b for the subset memory, the method may be bound by the constraint

|S\Pj|=b/K.

This makes sure that all the K partitions are equally represented in the final subset. This also helps in solving for each partition in parallel.

Alternatively, if N is determined not to be too big, then a submodular function by be designed based on a similarity or adjacency matrix (N×N) of the input data features 206. In this process the overall submodular function used may be

$$f ( S ) = {\sum }_{i = 1}^{M} {max}_{j ∈ S} {M}_{i , j} ,$$

where the (N×N) matrix must be calculated, in the subset 208, and stored in member 210 where N is the number of training examples.

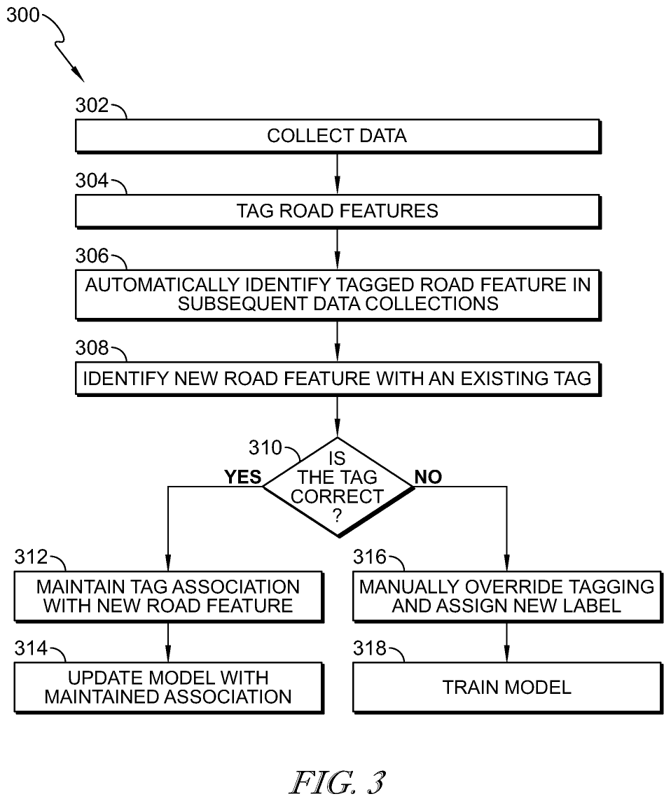

As shown in FIG. 3, continuous learning may be used in transportation vehicle training process to reduce manual human intervention in the training. A method is provided for reducing the in-transportation vehicle manual labeling and tagging of collected training data 300. According to this method, a vehicle collects sensor data comprising road features while driving at 302. Each road feature is tagged with a label and incorporated into a model, such as an AI model, in the transportation vehicle at 304. The feature tagging may be performed manually by a passenger in the vehicle with a tablet that is in communication with the model. Road features may be, for example, highways, parking lots, bridges, or other types of surfaces that transportation vehicles drive over. Additionally, road features may include various traffic signals, road signs, or road conditions such as unclear lane markings, toll booths, traffic, marching lanes, or relative positions and maneuvers of other transportation vehicles. This labelled road feature may then be automatically identified at a future time and location with the tagged label by the AI model at 306. Additionally, the AI model may automatically identify a new road feature and tag it with the same label at 308.

If the same label corresponds to the road feature at 310, then the same label can be maintained in association with the new road feature at 312 and updated in the model at 314. In this manner, the passenger does not have to manually enter a label again for the new road feature.

If the same label does not correspond to the new road feature at 310, the identification and tagging by the AI may be overridden by tagging the new road feature with a new label at 316. This override may be manually performed by the passenger, for example, on the tablet. The override may further trigger data to be recorded corresponding to the new road feature and a retraining of the model at 318 with the recorded data to automatically identify and tag the new road feature in subsequent data collections at 306.

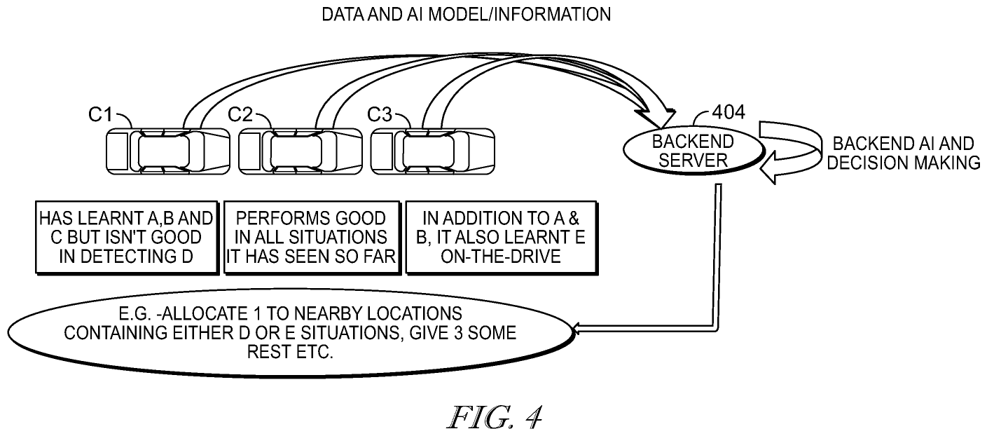

Thus, the one or more sensors are configured to capture data and record in response to a trigger, which may comprise, for example, the transportation vehicle entering into manual driving mode, receipt of a user input or an input from another artificial intelligence model such as the remote AI described herein in connection with FIG. 4. Once the AI model has been retrained, the retrained model may continue to automatically identify new road features until there is an override again.

FIG. 4 depicts a system in which a coordinated network of a fleet test cars is formed where every data collection transportation vehicle (C1 C2, C3) has a model and corresponding infrastructure 402 is connected to a central supervisory server 404. The vehicles may be either manually or autonomously driven with data being collected in the background. There is constant communication with the central supervisory server, which can track the performance of each of the active vehicles C1, C2, C3 and manage their future routes.

The central supervisory server 404 may have intelligence to retrain the respective model 402 of each car C1, C2, C3 with different data obtained from different sources. Central supervisory server 404 may also compare the difference or impact made by each of those chunks of data. Central supervisory server 404 may also retrain a new model M₍ᵢ₊₁₎ using all newly obtained data plus the past data stored as described in FIGS. 1-3. Central supervisory server 404 may also create a priority and ask all cars to collect more of such data. For example if C1's data seemed to be most relevant in creating maximum difference to the model change, then it will ask C2 and C3 to go into C1's location too. This request may be automatically carried out in the case of an autonomous vehicle and/or displayed as instructions to the driver.

The intelligence in the central supervisory server 404 may also learn from the combined information sent from different vehicles. This also helps the central supervisory server 404 in sending updated information to all the test cars C1, C2, C3.

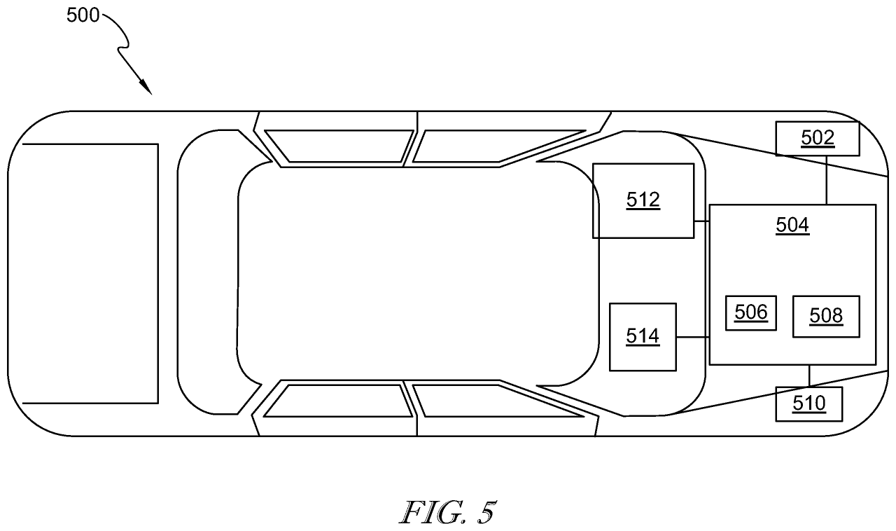

FIG. 5 illustrates a block diagram of an exemplary transportation vehicle that can incorporate the systems and methods described in FIGS. 1-4. Transportation vehicle 500 may be a car that includes one or more sensors 502 to record and collect data. The one or more sensors 502 may communicate collected data to a processor 504, which is in wired or wireless communication with one or more of a memory 506, a model 508, a transceiver 510, an ADAS or autonomous system 512, and a trainer interactive display 514, such as a tablet computer.

A further exemplary embodiment is a computer program for carrying out at least one of the methods described above when the computer program runs on a computer, a processor or a programmable hardware component. A further exemplary embodiment is also a digital storage medium which is machine- or computer-readable and which has electronically readable control signals which can interact with a programmable hardware component such that one of the methods described above is performed.

Depending on specific implementation requirements, exemplary embodiments may be implemented in hardware or in software. The implementation may be carried out using a digital storage medium, for example, a floppy disk, a DVD, a Blu-Ray disk, a CD, a ROM, a PROM, an EPROM, an EEPROM or a FLASH memory, a hard disk or some other magnetic or optical store on which electronically readable control signals are stored which can interact or interact with a programmable hardware component in such a way that the respective method is carried out.

A programmable hardware component may be formed by a processor, a computer processor (e.g., Central Processing Unit (CPU)), a graphics processor (e.g., Graphics Processing Unit (GPU)), a computer, a computer system, an Application Specific Integrated Circuit (ASIC), an Integrated Circuit (IC), a single-chip system (System on Chip (SOC)), a programmable logic element or a Field Programmable Gate Array (FPGA) with a microprocessor.

The memory may be a digital storage medium and may therefore be machine- or computer-readable. Some exemplary embodiments thus comprise a data carrier having electronically readable control signals that are able to interact with a programmable computer system or a programmable hardware component in such a way that one of the methods described herein is carried out. At least one exemplary embodiment is thus a data carrier (or a digital storage medium or a computer-readable medium) on which the program for carrying out one of the methods described herein is recorded.

It should be understood that some or all of the methodology explained above may be performed on, utilizing or with access to one or more servers, processors and associated memory. Unless specifically stated otherwise, and as may be apparent from the above description, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the terms “controller” and “processor” may refer to any device or portion of a device that processes electronic data from registers and/or memory to transform that electronic data into other electronic data that may be stored in registers and/or memory.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Although certain embodiments have been described and illustrated in exemplary forms with a certain degree of particularity, it is noted that the description and illustrations have been made by way of example only. Numerous changes in the details of construction, combination, and arrangement of parts and operations may be made.

By way of example, a transportation vehicle may be provided with a continual learning autonomous or ADAS system. The transportation vehicle may comprise one or more sensors configured to capture perception data as well as an autonomous or ADAS model configured to be continually trained in the transportation vehicle, and a scalable subset memory configured to store a subset of a dataset previously used to train a model. A means for continually training the model in the transportation vehicle may use captured perception data previously unseen and the subset and may generate a new subset of data to be stored so that the model avoids catastrophic forgetting. The means may comprise a processor.

In some embodiments, the one or more sensors are configured to capture data in response to a trigger. The trigger may comprise the transportation vehicle entering into manual driving mode. The trigger may comprise a user input. The trigger may comprise an input from another artificial intelligence model.

In some embodiments, the user input may be a label of a new situation or sign. The model may be configured to automatically tag and label the new situation or sign in all future encounters of the new situation or sign scenario.

In some embodiments, perception data may comprise driving scenario data, sign or object identification data, or other scene comprehension data. The scalable subset memory may be configured to store a subset representative of data used in each additional training of the model.

According to another embodiment, a method for continuous learning for artificial intelligence modules may comprise training the module with an original training dataset, identifying a subset of the training dataset that is representative without redundancy of the training dataset and storing the subset in a scalable subset memory, and retraining the module with new data while avoiding catastrophic forgetting of the original training dataset by using a new data and the subset in the retraining.

According to another embodiment, a method for reducing in-transportation vehicle manual labeling and tagging of training data may comprise tagging a data record of a road feature with a label in an artificial intelligence model of the transportation vehicle, automatically identifying the road feature at a future time and location with the label by the artificial intelligence model, automatically identifying a new road feature with the label by the artificial intelligence model, and overriding the identification by tagging the new road feature with a new label. The overriding may trigger data to be recorded by sensors corresponding to the new road feature. The model may be retrained to automatically identify and tag the new road feature.

In another example, system for controlling the training of artificial intelligence models in a plurality of cars may comprise: a plurality of transportation vehicles, and a central server configured to communicate with each transportation vehicle and receive update on the status of the data collection at each transportation vehicle and corresponding performance of each transportation vehicle in identifying and labeling driving scenarios, determine deficiencies in the transportation vehicle training and performance with respect to one or more of the driving scenarios. The central server may transmit instructions to each transportation vehicle regarding where each transportation vehicle should travel to in order to collect a new set of data. Each transportation vehicle may include a display and the instructions are displayed to the driver.

According to another embodiment, a method for continuously improving autonomous or advanced driver assistance systems over time executed on a processor may comprise training a model used by an autonomous or advanced driver assistance systems with training data and selecting and storing a subset of the training data in a scalable subset memory, testing the model performance in a transportation vehicle operating in autonomous or driver assistance mode, and performing retraining on the model with a second training data set including data collected during the testing and the stored subset. The method may further include storing a second subset of the retraining data in the scalable subset memory. The method may further comprise discarding any data not in the first and second subset. Selecting the subset of the training data is performed by determining a subset of the data that is representative of the diversity of driving scenarios in the training data. The subset is determined by solving a submodular optimization algorithm configured to select the most representative and diverse data observations into a memory-constrained subset. Data may be collected during the testing by sensing and recording data corresponding to scenarios not previously experienced by the model during training.

The one or more sensors are configured to capture data in response to a trigger. The trigger may comprise the transportation vehicle entering into manual driving mode. The trigger may comprise a user input. The trigger comprises an input from another artificial intelligence mode.

The method may comprise further testing the model performance in a transportation vehicle operating in autonomous or driver assistance mode, and performing additional training on the model with a third training data set including data collected during the further testing, the stored subset, and the second subset of data. The training data may include tagged data that has been assigned a label. The method may be continuously performed throughout the life of the transportation vehicle.

1. A transportation vehicle with a continual learning autonomous or adaptive driver assistance system comprising:
one or more sensors configured to capture perception data,
a model configured to be continually trained in the transportation vehicle,
a scalable subset memory configured to store a subset of a dataset previously used to train the model, and
means for continually training the model in the transportation vehicle using captured perception data previously unseen and the subset and generating a new subset of data to be stored so that the model avoids catastrophic forgetting.

2. The transportation vehicle of claim 1, wherein the one or more sensors are configured to capture data in response to a trigger

3. The transportation vehicle of claim 2, wherein the trigger comprises the transportation vehicle entering into manual driving mode.

4. The transportation vehicle of claim 2, wherein the trigger comprises a user input.

5. The transportation vehicle of claim 2, wherein the trigger comprises an input from another artificial intelligence model.

6. The transportation vehicle of claim 4, wherein the user input is a label of a new situation or sign and the model is configured to automatically tag and label the new situation or sign in all future encounters of the new situation or sign scenario.

7. The transportation vehicle of claim 1, wherein the means comprises a processor.

8. The transportation vehicle of claim 1, wherein the perception data comprises driving scenario data, sign or object identification data, or other scene comprehension data.

9. The transportation vehicle of claim 1, wherein the scalable subset memory is configured to store a subset representative of data used in each additional training of the model.

10. A method for continuous learning for artificial intelligence modules comprising:
training the module with an original training dataset,
identifying a subset of the training dataset that is representative without redundancy of the training dataset and storing the subset in a scalable subset memory,
retraining the module with new data while avoiding catastrophic forgetting of the original training dataset by using a new data and the subset in the retraining.

11. A method for reducing in-transportation vehicle manual labeling and tagging of training data comprising:
tagging a data record of a road feature with a label in an artificial intelligence model of the transportation vehicle,
automatically identifying the road feature at a future time and location with the label by the artificial intelligence model,
automatically identifying a new road feature with the label by the artificial intelligence model, overriding the identification by tagging the new road feature with a new label, wherein the overriding triggers data to be recorded by sensors corresponding to the new road feature, and
retraining the model to automatically identify and tag the new road feature.

12. A system for controlling the training of artificial intelligence models in a plurality of cars comprising:
a plurality of transportation vehicles each provided in accordance with claim 1,
a central server configured to communicate with each transportation vehicle and receive update on the status of the data collection at each transportation vehicle and corresponding performance of each transportation vehicle in identifying and labeling driving scenarios, determine deficiencies in the transportation vehicle training and performance with respect to one or more of the driving scenarios, and transmit instructions to each transportation vehicle regarding where each transportation vehicle should travel to in order to collect a new set of data.

13. The system of claim 12, wherein each transportation vehicle includes a display and the instructions are displayed to the driver.

14. A system for controlling the training of artificial intelligence models in a plurality of cars comprising:
a plurality of transportation vehicles each provided in accordance with claim 11,
a central server configured to communicate with each transportation vehicle and receive update on the status of the data collection at each transportation vehicle and corresponding performance of each transportation vehicle in identifying and labeling driving scenarios, determine deficiencies in the transportation vehicle training and performance with respect to one or more of the driving scenarios, and transmit instructions to each transportation vehicle regarding where each transportation vehicle should travel to in order to collect a new set of data.

15. A method for continuously improving autonomous or advanced driver assistance systems over time, the method executed on a processor and comprising:
training a model used by an autonomous or advanced driver assistance systems with training data and selecting and storing a subset of the training data in a scalable subset memory
testing the model performance in a transportation vehicle operating in autonomous or driver assistance mode, and
performing retraining on the model with a second training data set including data collected during the testing and the stored subset and storing a second subset of the retraining data in the scalable subset memory.

16. The method of claim 15, further comprising discarding any data not in the first and second subset.

17. The method of claim 15, further comprising selecting the subset of the training data is performed by determining a subset of the data that is representative of the diversity of driving scenarios in the training data.

18. The method of claim 17, wherein the subset is determined by solving a submodular optimization algorithm configured to select the most representative and diverse data observations into a memory constrained subset.

19. The method of claim 15, further comprising collecting data during the testing by sensing and recording data corresponding to scenarios not previously experienced by the model during training.

20. The method of claim 15, wherein the one or more sensors are configured to capture data in response to a trigger

21. The method of claim 20, wherein the trigger comprises the transportation vehicle entering into manual driving mode.

22. The method of claim 20, wherein the trigger comprises a user input.

23. The method of claim 20, wherein the trigger comprises an input from another artificial intelligence model.

24. The method of claim 15, further comprising further testing the model performance in a transportation vehicle operating in autonomous or driver assistance mode, and performing additional training on the model with a third training data set including data collected during the further testing, the stored subset, and the second subset of data.

25. The method of claim 15, wherein the method is continuously performed throughout the life of the transportation vehicle.

26. The method of claim 15, wherein the training data includes tagged data that has been assigned a label.
